(19) United States
(12) Patent Application Publication
(10) Pub. No.: US 2024/0428549 A1
(43) Pub. Date: Dec. 26, 2024

(54) OBJECT DETECTION DEVICE AND OBJECT DETECTION METHOD

(71) Applicant: NEC Corporation, Tokyo (JP)

(72) Inventors: Mizuho Katayama, Tokyo (JP); Seiya Shibata, Tokyo (JP); Hiromitsu Fuchigami, Tokyo (JP)

(73) Assignee: NEC Corporation, Tokyo (JP)

(21) Appl. No.: 18/736,715

(22) Filed: Jun. 7, 2024

(30) Foreign Application Priority Data
Jun. 23, 2023 (JP) 2023-103479

(51) Int. Cl. G06V 10/20; G06T 7/55

(52) U.S. Cl. CPC G06V 10/255; G06T 7/55; G06V 2201/07

(57) ABSTRACT

The object detection device includes two or more detection means that perform detection operation of deriving bounding boxes of a detection target object and scores indicating reliability of the bounding boxes, based on a given image. Accuracy of the detection operation of each detection means is different. The division means divides an input image to obtain partial images corresponding to partial regions indicated by region setting values, when a pair of the region setting values that indicate the partial regions in the input image and designation information designating the detection means to be input destination for partial images corresponding to the partial regions is given. The partial image input means inputs the individual partial images to designated detection means. Each NMS means eliminates bounding box overlap in overlapping bounding boxes output from corresponding detection means.

### INCORPORATION BY REFERENCE

This application is based upon and claims the benefit of priority from Japanese patent application No. 2023-103479, filed on Jun. 23, 2023, the disclosure of which is incorporated herein in its entirety by reference.

### TECHNICAL FIELD

The present invention relates to an object detection device, an object detection method, and an object detection program.

### BACKGROUND ART

In general, object detection techniques are known, for example, YOLOX (You Only Look Once X). YOLOX is described, for example, in NPL 1.

A detection operation is an operation to derive bounding boxes of a detection target object and scores indicating reliability of the bounding boxes, based on a given image. In this operation, a label indicating a type of the detection target object is also derived for each bounding box.

### CITATION LIST

### Non Patent Literature

NPL 1: Zheng Ge, et al., “YOLOX: Exceeding YOLO Series in 2021”, [online], [retrieved on May 19, 2023], Internet <URL: https://arxiv.org/pdf/2107.08430.pdf>

### SUMMARY

The purpose of the present invention is to provide an object detection device, an object detection method, and an object detection program that can shorten time required to obtain detection result.

An object detection device according to the present invention is an object detection device including: a memory storing instructions; and a processor configured to execute the instructions to implement: two or more detection units that perform detection operation of deriving bounding boxes of a detection target object and scores indicating reliability of the bounding boxes, based on a given image, wherein accuracy of the detection operation of each detection unit is different, wherein the processor is further configured to execute the instructions to implement: a division unit that divides an input image to obtain partial images corresponding to partial regions indicated by region setting values, when a pair of the region setting values that indicate the partial regions in the input image and designation information designating the detection unit to be input destination for partial images corresponding to the partial regions is given; a partial image input unit that inputs the individual partial images to designated detection unit; and NMS (Non-Maximum Suppression) units, each of which is provided for each of the individual detection units; wherein each NMS unit eliminates bounding box overlap in overlapping bounding boxes output from corresponding detection unit, and wherein the partial image input unit does not input a partial image for which no detection unit is designated as the input destination to any of the detection units.

An object detection method according to the present invention is an object detection method of an object detection device comprising: two or more detection units that perform detection operation of deriving bounding boxes of a detection target object and scores indicating reliability of the bounding boxes, based on a given image, wherein accuracy of the detection operation of each detection unit is different, wherein a division unit divides an input image to obtain partial images corresponding to partial regions indicated by region setting values, when a pair of the region setting values that indicate the partial regions in the input image and designation information designating the detection unit to be input destination for partial images corresponding to the partial regions is given; a partial image input unit inputs the individual partial images to designated detection unit; and NMS (Non-Maximum Suppression) units, each of which is provided for each of the individual detection units, eliminate bounding box overlap in overlapping bounding boxes output from corresponding detection unit, and wherein the partial image input unit does not input a partial image for which no detection unit is designated as the input destination to any of the detection units.

A non-transitory computer-readable recording medium according to the present invention is a non-transitory computer-readable recording medium in which an object detection program is recorded, wherein the object detection program allows a computer to function as an object detection device, wherein the object detection device comprises: two or more detection units that perform detection operation of deriving bounding boxes of a detection target object and scores indicating reliability of the bounding boxes, based on a given image, wherein accuracy of the detection operation of each detection unit is different, wherein the object detection device further comprises: a division unit that divides an input image to obtain partial images corresponding to partial regions indicated by region setting values, when a pair of the region setting values that indicate the partial regions in the input image and designation information designating the detection unit to be input destination for partial images corresponding to the partial regions is given; a partial image input unit that inputs the individual partial images to designated detection unit; and NMS (Non-Maximum Suppression) units, each of which is provided for each of the individual detection units; wherein each NMS unit eliminates bounding box overlap in overlapping bounding boxes output from corresponding detection unit, and wherein the partial image input unit does not input a partial image for which no detection unit is designated as the input destination to any of the detection units.

### BRIEF DESCRIPTION OF THE DRAWINGS

FIG. 1 It depicts a block diagram showing an example configuration of an object detection device of the first example embodiment of the present invention.

FIG. 2 It depicts a schematic diagram showing derivation of multiple bounding boxes for one detection target object in a partial image.

FIG. 3 It depicts a schematic diagram showing an example of bounding boxes that exceed range of a partial image.

FIG. 4 It depicts a schematic diagram showing an example of bounding boxes that exceed range of a partial image.

FIG. 5 It depicts a schematic diagram showing an example of an input image.

FIG. 6 It depicts a schematic diagram showing examples of three identified partial regions.

FIG. 7 It depicts a schematic diagram showing examples of three partial images.

FIG. 8 It depicts a schematic diagram showing an example of the result of the detection operation performed by the first detection unit 4 on the partial image 74a.

FIG. 9 It depicts a schematic diagram showing an example of the result of the detection operation performed by the second detection unit 5 on the partial image 74b.

FIG. 10 It depicts a schematic diagram showing an example of the result of the detection operation performed by the first detection unit 4 on the partial image 74c.

FIG. 11 It depicts a schematic diagram showing the state in which bounding box overlap shown in FIG. 8 is eliminated.

FIG. 12 It depicts a schematic diagram showing the state in which bounding box overlap shown in FIG. 10 is eliminated.

FIG. 13 It depicts a schematic diagram showing the state in which bounding box overlap shown in FIG. 9 is eliminated.

FIG. 14 It depicts a flowchart showing an example of the processing flow of the object detection device of the first example embodiment.

FIG. 15 It depicts a schematic diagram showing a situation where two bounding boxes are obtained for a detection target object that straddles the boundary of two adjacent partial images.

FIG. 16 It depicts a schematic diagram showing the overlap of the bounding box 211 and the bounding box 212.

FIG. 17 It depicts a block diagram showing an example configuration of the object detection device of the second example embodiment of the present invention.

FIG. 18 It depicts a flowchart showing an example of the processing flow of the object detection device of the second example embodiment.

FIG. 19 It depicts a block diagram showing a variation of each example embodiment.

FIG. 20 It depicts a schematic block diagram showing an example configuration of a computer related to the object detection device of the present invention.

FIG. 21 It depicts a block diagram showing an overview of the object detection device of the present invention.

### EXAMPLE EMBODIMENT

The following is a description of the example embodiments of the present invention with reference to the drawings.

### Example Embodiment 1

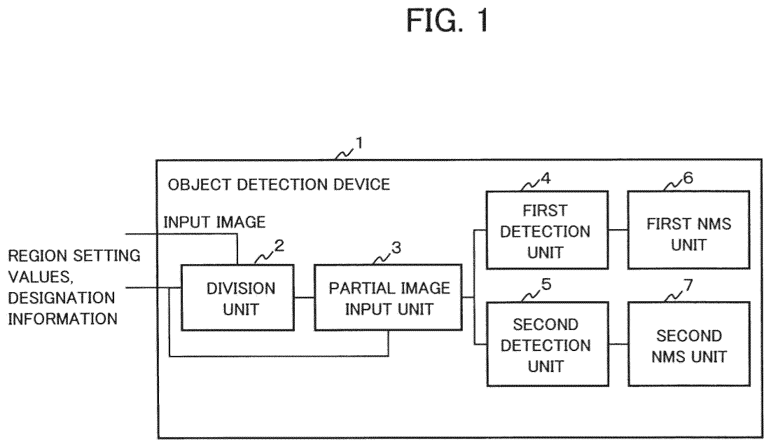

FIG. 1 is a block diagram showing an example configuration of an object detection device of the first example embodiment of the present invention. The object detection device 1 includes a division unit 2, a partial image input unit 3, a first detection unit 4, a second detection unit 5, a first NMS (Non-Maximum Suppression) unit 6, and a second NMS unit 7.

The object detection device 1 includes two or more detection units that perform the detection operation. As mentioned above, the detection operation is an operation to derive bounding boxes of a detection target object and scores indicating reliability of the bounding boxes, based on a given image. In this operation, for each bounding box, a label indicating a type of the detection target object is also derived. When the detection target object is a “person”, a “vehicle”, etc., a label such as “person” or “vehicle” is derived. To avoid complicating the drawing, scores and labels are omitted in the drawings.

FIG. 1 shows an example where the object detection device 1 includes a first detection unit 4 and a second detection unit 5 as detection units that perform the detection operation, but the object detection device 1 may include three or more detection units.

The accuracy of the detection operation of each detection unit (in the example shown in FIG. 1, the first detection unit 4 and the second detection unit 5) is different. In the example shown in FIG. 1, it is assumed that the accuracy of the detection operation of the first detection unit 4 is higher than the accuracy of the detection operation of the second detection unit 5. There is a trade-off between the accuracy of the detection operation and the time of the detection operation; the higher the accuracy of the detection operation, the slower the time of the detection operation. Thus, in this example, the accuracy of the detection operation of the first detection unit 4 is higher than the accuracy of the detection operation of the second detection unit 5, but the second detection unit 5 can derive bounding boxes, etc. in a shorter time. For example, when YOLOX-X is applied to the first detection unit 4, an object detection algorithm less accurate than YOLOX-X is applied to the second detection unit 5.

As described below, an input image is input to the object detection device 1, and partial images of the input image obtained by the division unit 2 are input to the first detection unit 4 and second detection unit 5 by the partial image input unit 3. The first detection unit 4 and the second detection unit 5 respectively execute the detection operation for each input partial image.

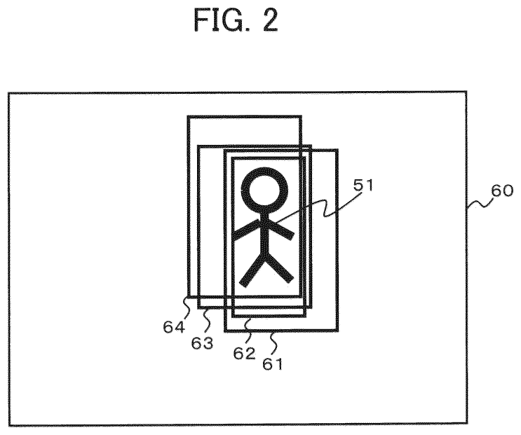

The first detection unit 4 and the second detection unit 5 derive multiple bounding boxes for each individual detection target object in the partial image. In the following explanation, the case where the detection target object is a “person” will be used as an example. FIG. 2 is a schematic diagram showing derivation of multiple bounding boxes for one detection target object (one person) in the partial image. In FIG. 2, for simplicity of explanation, it is assumed that only one person 51 is in the partial image. When the partial image 60 is input, the first detection unit 4 derives multiple bounding boxes 61-64 for one person 51 (detection target object). Here, the case in which the first detection unit 4 derives four bounding boxes 61-64 for one person 51 is shown as an example, but it is common for the number of bounding boxes to be derived for one person 51 to be greater. The first detection unit 4 also derives a score and a label for each bounding box, but as mentioned above, the scores and the labels are omitted in the drawing. When a partial image is input, the second detection unit 5 also derives multiple bounding boxes for each individual person in the partial image, and also derives a score and a label for each bounding box.

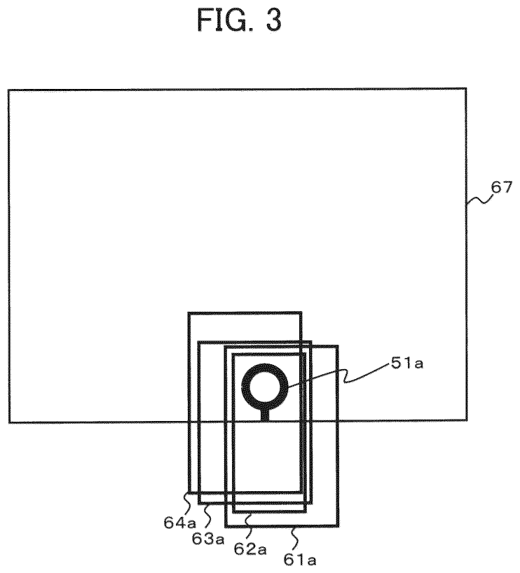

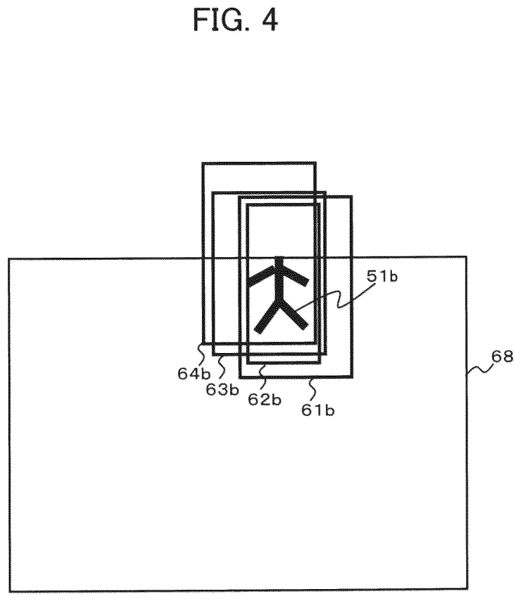

The first detection unit 4 and the second detection unit 5 may also derive bounding boxes that exceed range of the input partial image. This situation occurs when only a portion of the detection target object is reflected at the edge of the partial image. For example, it is assumed that the head 51a of person 51 is reflected at the edge of partial image 67. When such a partial image 67 is input to the first detection unit 4, the first detection unit 4 derives bounding boxes 61a-64a that exceed the range of the input partial image 67, as illustrated in FIG. 3. In this case, the first detection unit 4 also derives a score and a label for each bounding box. The same is true for the second detection unit 5. For example, it is assumed that the portion 51b below the neck of person 51 is reflected at the edge of partial image 68. When such a partial image 68 is input to the second detection unit 5, the second detection unit 5 derives bounding boxes 61b to 64b that exceed the range of the input partial image 68, as illustrated in FIG. 4. In this case, the second detection unit 5 also derives a score and a label for each bounding box.

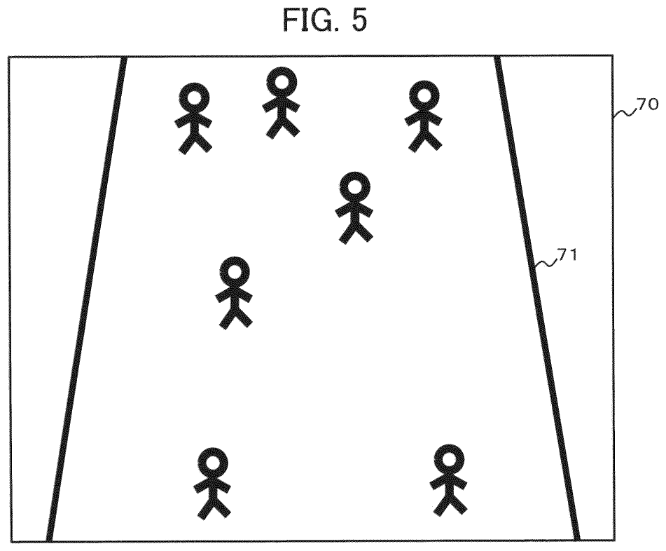

An input image is input to the object detection system 1. FIG. 5 is a schematic diagram showing an example of an input image. FIG. 5 shows an example of an input image 70, which shows people scattered on a road 71.

Pairs of region setting values and designation information are input to the object detection device 1. Two or more pairs of the region setting values and the designation information are assumed to be input. In the following, the case where three pairs of the region setting values and the designation information are input is used, as an example.

The region setting values are setting values that indicate a partial region in the input image 70. The region setting values are represented by four values, for example, [x, y, w, h]. [x, y] are coordinates indicating a point in the input image 70, w indicates the width of the partial region, and h indicates the height of the partial region. Such region setting values [x, y, w, h] can indicate one partial region in the input image 70. However, the region setting values may be expressed in other formats. One set of region setting values identifies one partial region, resulting in one partial image.

The designation information is information that designates the detection unit (in this example, the first detection unit 4 or the second detection unit 5) to be the input destination for the partial images corresponding to the partial regions indicated by the region setting values that form the pair. In the designation information, it may be designated that there is no detection unit to be the input destination. For example, “0” indicates that there is no input destination, “1” indicates that the first detection unit 4 is the input destination, and “2” indicates that the second detection unit 5 is the input destination.

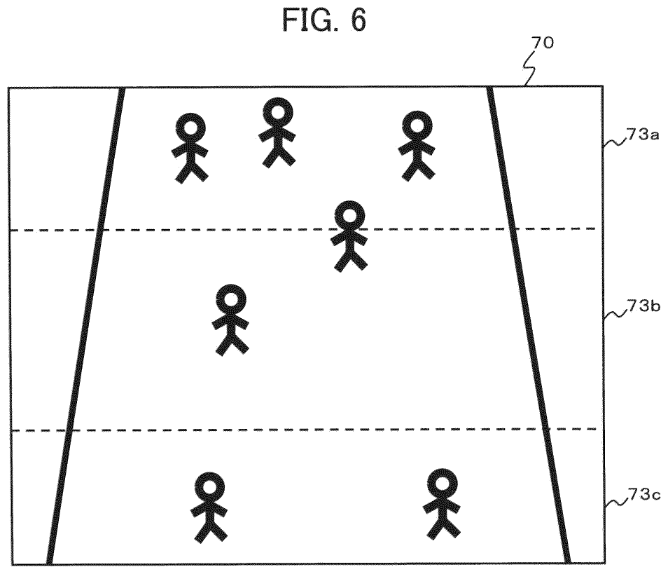

When a pair of region setting values and designation information is given, the division unit 2 divides the input image 70 to obtain a partial images corresponding to the partial regions indicated by the region setting values. The division unit 2 first identifies, for each set of region setting values, the partial region indicated by the region setting values. In this example, three pairs of region setting values and the designation information are input. Therefore, the division unit 2 identifies three partial regions. FIG. 6 is a schematic diagram showing examples of three identified partial regions. It is assumed that the division unit 2 identifies three partial regions 73a, 73b, and 73c based on the three set of region setting values. It is assumed here that the partial regions 73a and 73c are regions in the input image 70 that reflect the breaks in the road that persons enter or exit, and that the region setting values indicating these regions are associated with the designation information indicating that the first detection unit 4 is the input destination. It is assumed that the region setting values indicating the partial region 73b is associated with the designation information indicating that the second detection unit 5 is the input destination.

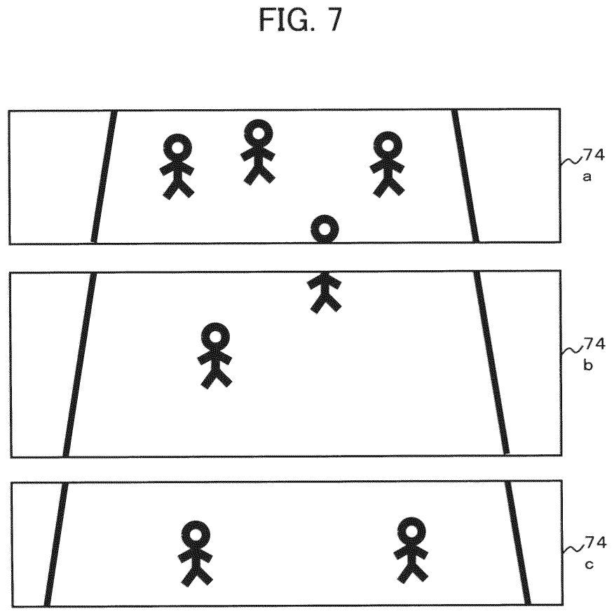

The division unit 2 divides the input image 70 to obtain partial images corresponding to the respective identified partial regions. In this example, three partial images are obtained. FIG. 7 is a schematic diagram showing these three partial images. The division unit 2 divides the input image 70 to obtain a partial image 74a (see FIG. 7) that corresponds to partial region 73a. Similarly, the division unit 2 divides the input image 70 to obtain a partial image 74b (see FIG. 7) that corresponds to partial region 73b. Similarly, the division unit 2 divides the input image 70 to obtain a partial image 74c (see FIG. 7) that corresponds to partial region 73c. As a result, three partial images 74a, 74b, 74c are obtained.

The partial image input unit 3 inputs the individual partial images obtained by the division unit 2 to the designated detection unit (in this example, the first detection unit 4 or second detection unit 5). In this example, the region setting values indicating the partial region 73a is associated with the designation information indicating that the first detection unit 4 is the input destination. Similarly, the region setting values indicating the partial region 73c is associated with the designation information indicating that the first detection unit 4 is the input destination. Also, the region setting values indicating the partial region 73b is associated with the designation information indicating that the second detection unit 5 is the input destination. Accordingly, the partial image input unit 3 inputs the partial image 74a (see FIG. 7) corresponding to the partial region 73a to the first detection unit 4. Similarly, the partial image input unit 3 inputs the partial image 74c (see FIG. 7) corresponding to the partial region 73c to the first detection unit 4. The partial image input unit 3 also inputs the partial image 74b (see FIG. 7) corresponding to the partial region 73b to the second detection unit 5.

As mentioned above, the designation information may also designate that there is no detection unit to be the input destination. The partial image input unit 3 does not input to either the first detection unit 4 or the second detection unit 5 a partial image designated as having no detection unit to be input to (in other words, a partial image for which no detection unit is designated as the input destination). For partial images that are not input to either the first detection unit 4 or the second detection unit 5, no detection operation is performed and no bounding box, score, or label is derived.

As mentioned above, the first detection unit 4 and the second detection unit 5 derive multiple bounding boxes for each individual detection target object in the partial image and derive a score and a label for each bounding box. As mentioned above, the accuracy of the detection operation of the first detection unit 4 is higher than the accuracy of the detection operation of the second detection unit 5, but the second detection unit 5 can derive bounding boxes, etc. in a shorter time. Since the first detection unit 4 and the second detection unit 5 have already been described, a detailed description is omitted here.

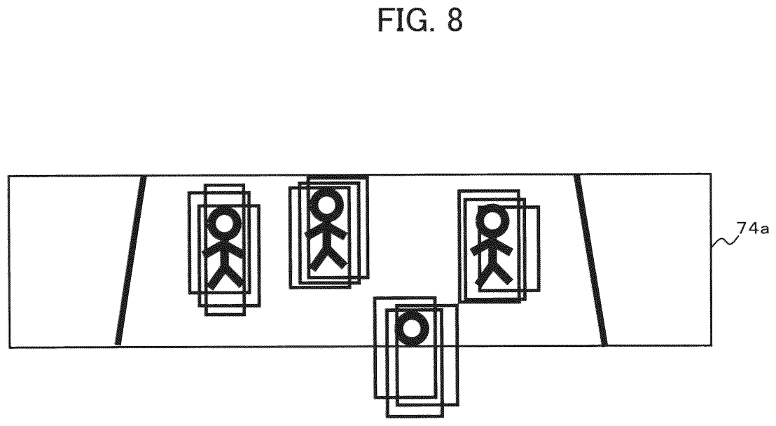

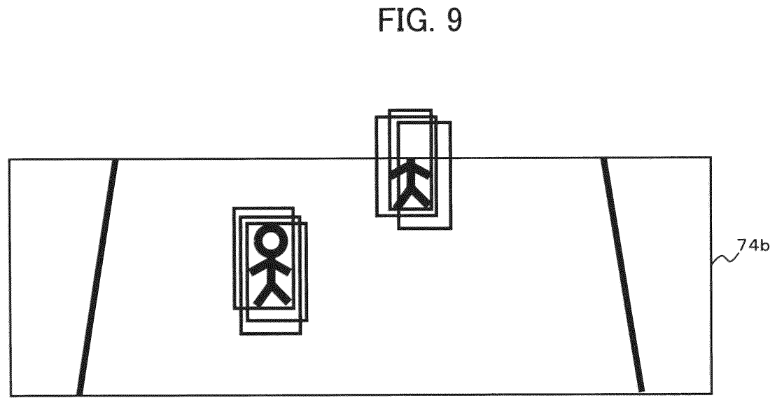

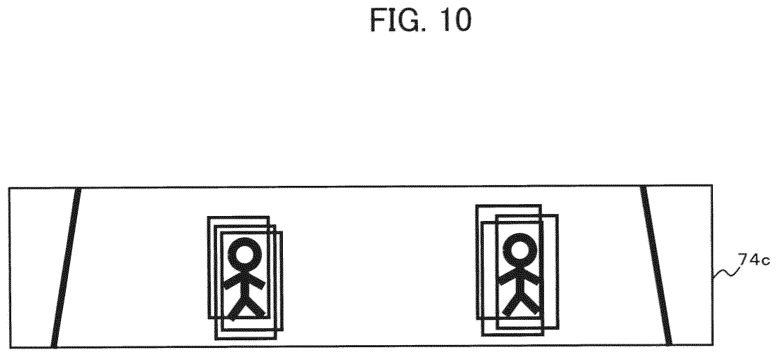

FIG. 8 is a schematic diagram showing an example of the result of the detection operation performed by the first detection unit 4 on the partial image 74a. FIG. 9 is a schematic diagram showing an example of the result of the detection operation performed by the second detection unit 5 on the partial image 74b. FIG. 10 is a schematic diagram showing an example of the result of the detection operation performed by the first detection unit 4 on the partial image 74c.

An NMS unit is provided for each individual detection unit. In the example shown in FIG. 1, the object detection device 1 includes a first detection unit 4 and a second detection unit 5, so the object detection device 1 includes a first NMS unit 6 corresponding to the first detection unit 4 and a second NMS unit 7 corresponding to the second detection unit 5.

The first NMS unit 6 and the second NMS unit 7 eliminate bounding box overlap in overlapping bounding boxes output from the corresponding detection unit. That is, the first NMS unit 6 eliminates bounding box overlap in overlapping bounding boxes output from the corresponding first detection unit 4. The second NMS unit 7 eliminates bounding box overlap in overlapping bounding boxes output from the corresponding second detection unit 5.

For each partial image, the first NMS unit 6 and the second NMS unit 7 eliminate bounding box overlap for bounding boxes derived from the partial image, for each partial image. This operation is common to the first NMS unit 6 and the second NMS unit 7.

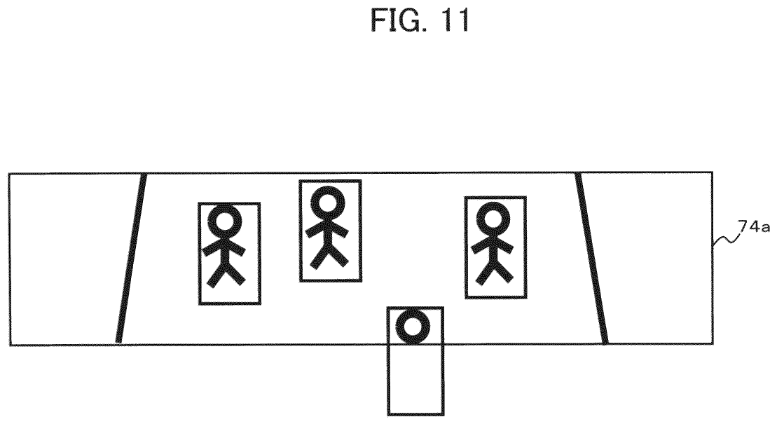

It is assumed that the result of the detection operation performed by the first detection unit 4 on the partial image 74a (see FIG. 8) is output to the first NMS unit 6. In this case, the first NMS unit 6 compares the IoU (Intersection over Union) with a predetermined NMS threshold with respect to the combination of any two bounding boxes obtained from the output bounding boxes (see FIG. 8), and when the IoU is greater than or equal to the NMS threshold, the bounding box with the lower score is removed, and when the IoU is less than the NMS threshold, both of the two bounding boxes are left. When the first NMS unit 6 removes a bounding box, the first NMS unit 6 also removes the score and label corresponding to the bounding box. The first NMS unit 6 determines the combination of any two bounding boxes in sequence and repeats the same process. By this process, the first NMS unit 6 eliminates bounding box overlap. FIG. 11 is a schematic diagram showing the state in which bounding box overlap shown in FIG. 8 is eliminated. However, when the IoU of two bounding boxes is less than the NMS threshold, those two bounding boxes may remain partially overlapped.

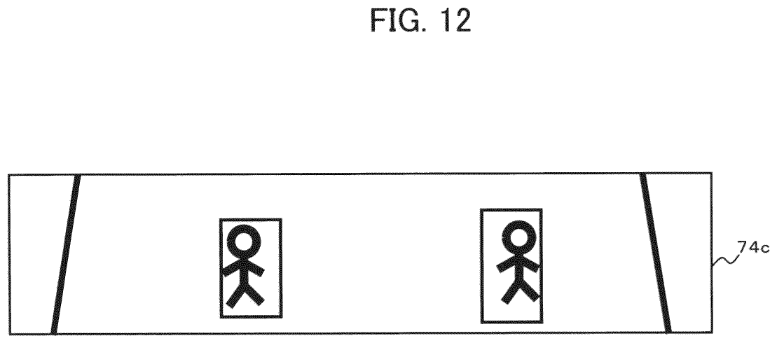

When the result of the detection operation performed by the first detection unit 4 on the partial image 74c (see FIG. 10) is output to the first NMS unit 6, the first NMS unit 6 also eliminates the bounding box overlap by the above process. FIG. 12 is a schematic diagram showing the state in which bounding box overlap shown in FIG. 10 is eliminated.

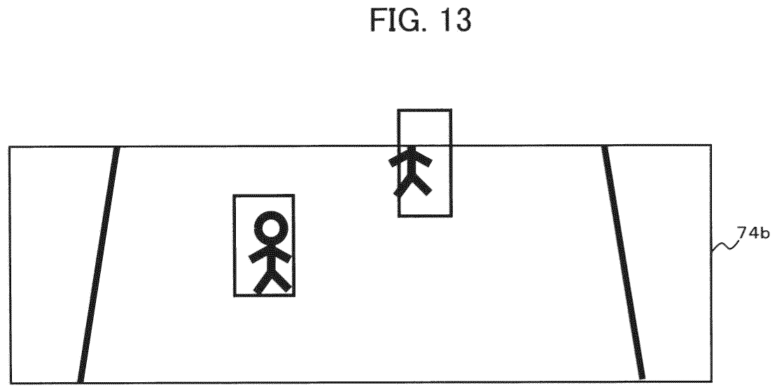

It is assumed that the result of the detection operation performed by the second detection unit 5 on the partial image 74b (see FIG. 9) is output to the second NMS unit 7. In this case, the second NMS unit 7 compares the IoU with the predetermined NMS threshold with respect to the combination of any two bounding boxes obtained from the output bounding boxes (see FIG. 9), and when the IoU is greater than or equal to the NMS threshold, the bounding box with the lower score is removed, and when the IoU is less than the NMS threshold, both of the two bounding boxes are left. When the second NMS unit 7 removes a bounding box, the second NMS unit 7 also removes the score and label corresponding to the bounding box. The second NMS unit 7 determines the combination of any two bounding boxes in sequence and repeats the same process. By this process, the second NMS unit 7 eliminates bounding box overlap. FIG. 13 is a schematic diagram showing the state in which bounding box overlap shown in FIG. 9 is eliminated. However, as mentioned above, when the IoU of two bounding boxes is less than the NMS threshold, those two bounding boxes may remain partially overlapped.

The division unit 2, the partial image input unit 3, the first detection unit 4, the second detection unit 5, the first NMS unit 6, and the second NMS unit 7 are realized, for example, by a CPU (Central Processing Unit) of a computer operating according to an object detection program. In this case, the CPU may read the object detection program from a program storage medium such as a program storage device of the computer, and operate as the division unit 2, the partial image input unit 3, the first detection unit 4, the second detection unit 5, the first NMS unit 6, and the second NMS unit 7 according to the object detection program.

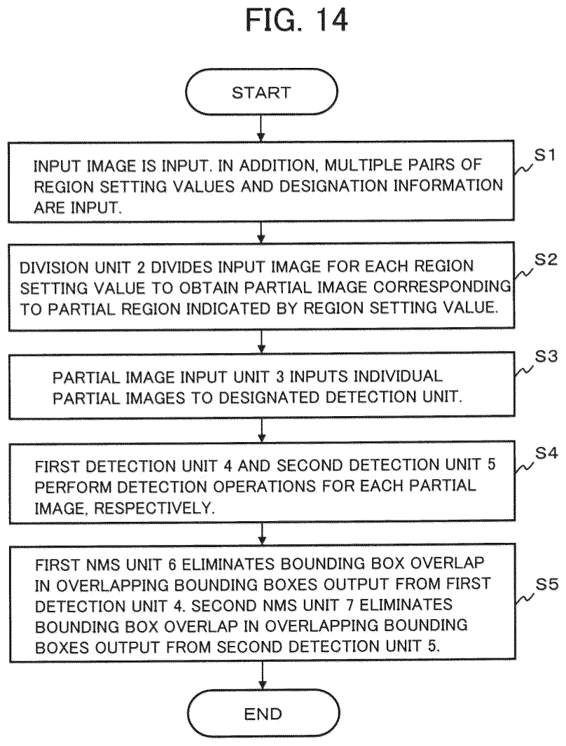

Next, the processing flow is explained. FIG. 14 is a flowchart showing an example of the processing flow of the object detection device of the first example embodiment. The explanation of matters that have already been explained are omitted as appropriate.

First, an input image is input to the object detection device 1. In addition, multiple pairs of the region setting values and the designation information are input to the object detection device 1 (step S1).

Next, the division unit 2 divides the input image for each region setting value to obtain a partial image corresponding to the partial region indicated by the region setting value. (step S2).

The partial image input unit 3 inputs the individual partial images obtained in step S2 to the designated detection unit (the first detection unit 4 or the second detection unit 5) (step S3).

The first detection unit 4 and the second detection unit 5 perform detection operations for each partial image, respectively (step S4).

Next, the first NMS unit 6 eliminates bounding box overlap in overlapping bounding boxes output from the first detection unit 4. Similarly, the second NMS unit 7 eliminates bounding box overlap in overlapping bounding boxes output from the second detection unit 5 (step S5).

According to the object detection device 1 of the first example embodiment, the entire input image is not input to the first detection unit 4, and partial images smaller than the input image are input to the first detection unit 4. Partial images that are not input to the first detection unit 4 are either input to the second detection unit 5 or are not input to either the first detection unit 4 or the second detection unit 5. Therefore, the time required to obtain the detection results (processing results of the first NMS unit 6 and the second NMS unit 7) can be shortened. However, when this effect is not required, the entire input image may be input to the first detection unit 4.

FIG. 1 shows the case where two NMS units (the first NMS unit 6 and the second NMS unit 7) are provided. A configuration in which one NMS unit is provided in the object detection device 1 and the NMS unit eliminates bounding box overlap in the entire bounding boxes output from the first 4 detection unit and the second 5 detection unit is also conceivable. However, in this case, the process of eliminating bounding box overlap is time-consuming because the number of combinations of any two bounding boxes is huge. Therefore, it is not preferable to have a single NMS unit. It is preferable to have a configuration in which the NMS unit is provided for each individual detection unit, as in the first example embodiment.

### Example Embodiment 2

In the first example embodiment, two bounding boxes could be obtained for a detection target object that straddles the boundary of two adjacent partial images. From the viewpoint of accuracy of the object detection device, it is preferable to obtain one bounding box for one detection target object.

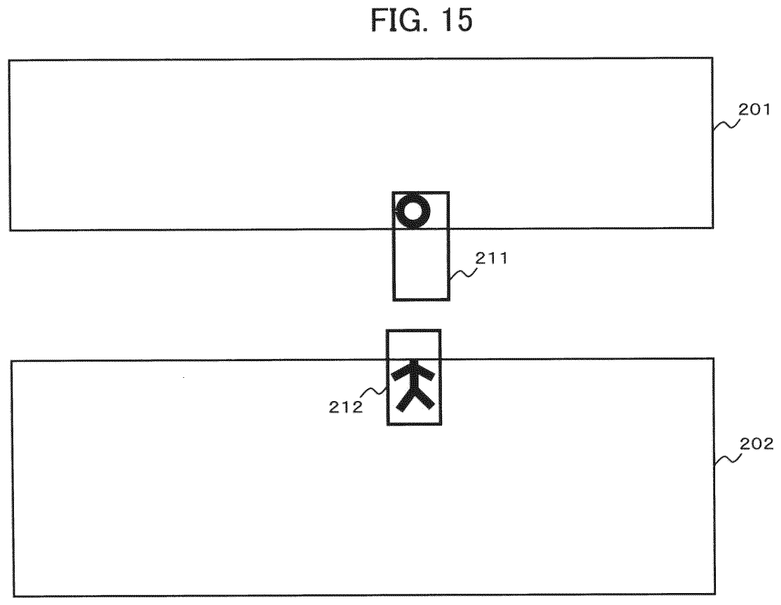

FIG. 15 is a schematic diagram showing a situation where two bounding boxes are obtained for a detection target object that straddles the boundary of two adjacent partial images. In the following description, the bounding box is the bounding box obtained as a result of processing by the first NMS unit 6 or the second NMS unit 7. In the example shown in FIG. 15, partial image 201 and partial image 202 are adjacent partial images. It is assumed that the partial image 201 shows the head of a person (a detection target object) and that a bounding box 211 is obtained based on that head. It is assumed that partial image 202 shows the part of the person below the neck, and that a bounding box 212 is obtained based on the part of the person. In this case, two bounding boxes 211 and 212 are obtained from one person, which is not preferable.

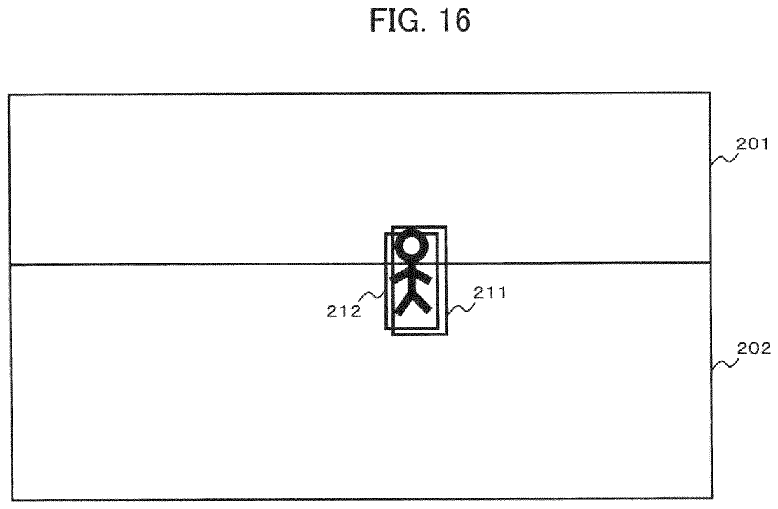

FIG. 16 is a schematic diagram showing the overlap of the bounding box 211 and the bounding box 212. As shown in FIG. 16, the bounding box 211 and the bounding box 212 overlap. The object detection device of the second example embodiment removes one of the overlapping bounding boxes 211 and 212 from the bounding boxes obtained as a result of processing by the first NMS unit 6 or the second NMS unit 7.

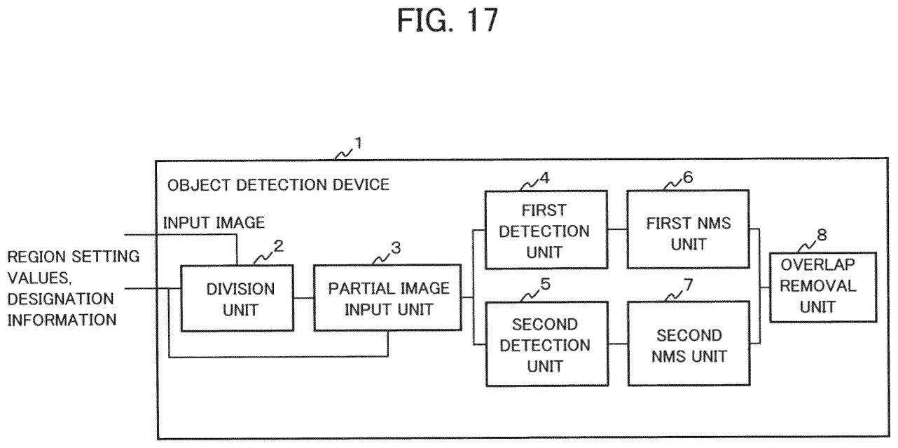

FIG. 17 is a block diagram showing an example configuration of the object detection device of the second example embodiment of the present invention. The object detection device 1 includes a division unit 2, a partial image input unit 3, a first detection unit 4, a second detection unit 5, a first NMS unit 6, a second NMS unit 7, and an overlap removal unit 8. The object detection device 1 may include three or more pairs of a detection unit and an NMS unit. The division unit 2, the partial image input unit 3, the first detection unit 4, the second detection unit 5, the first NMS unit 6 and the second NMS unit 7 in the second example embodiment are the same as the division unit 2, the partial image input unit 3, the first detection unit 4, the second detection unit 5, the first NMS unit 6 and the second NMS unit 7 in the first example embodiment and the explanation of them is omitted.

The overlap removal unit 8 processes bounding boxes that straddle the boundary of two adjacent partial images among the bounding boxes obtained as a result of processing by the first NMS unit 6 and the second NMS unit 7.

One of the two adjacent partial images is noted as the first partial image and the other partial image is noted as the second partial image. In the example shown in FIG. 16, it is assumed that the partial image 201 is the first partial image and the partial image 202 is the second partial image.

The bounding box obtained from the first partial image and overlapping with the boundary of two adjacent partial images is denoted as the first bounding box. The bounding box obtained from the second partial image and overlapping with the boundary of two adjacent partial images is denoted as the second bounding box. In the example shown in FIG. 16, the bounding box 211 obtained from the first partial image 201 and overlapping with the boundary corresponds to the first bounding box. The bounding box 212 obtained from the second partial image 202 and overlapping with the boundary corresponds to the second bounding box.

The overlap removal unit 8 removes either the first bounding box or the second bounding box when the first bounding box and the second bounding box overlap. For example, in the example shown in FIG. 16, the overlap removal unit 8 removes either the first bounding box 211 or the second bounding box 212.

The overlap removal unit 8 determines whether the first bounding box and the second bounding box overlap or not as follows. The overlap removal unit 8 takes out a pair of the first bounding box (a bounding box obtained from the first partial image and overlapping with the boundary) and the second bounding box (a bounding box obtained from the second partial image and overlapping with the boundary) from bounding boxes obtained as a result of processing by the first NMS unit 6 and the second NMS unit 7. When the IoU of the first bounding box and the second bounding box in the pair of the first bounding box and the second bounding box is greater than or equal to the predetermined overlap determination threshold, the overlap removal unit 8 determines that the first bounding box and the second bounding box overlap.

When the IoU is less than the overlap determination threshold, the overlap removal unit 8 determines that the first bounding box and the second bounding box do not overlap. The overlap determination threshold is defined to be smaller than the aforementioned NMS threshold.

The overlap removal unit 8 determines whether or not the two bounding boxes overlap for each pair of the first bounding box and the second bounding box, and when they overlap, the overlap removal unit 8 removes either the first bounding box or the second bounding box. When there is no overlap, the overlap removal unit 8 leaves both of the bounding boxes.

Next, it is explained how the overlap removal unit 8 removes either the first bounding box or the second bounding box. The following describes three methods for removing either the first bounding box or the second bounding box, but is not limited to these three methods.

### [First Method]

In the first method, the overlap removal unit 8 removes the bounding box with the lower score among the first bounding box and the second bounding box. As a result, either the first bounding box or the second bounding box is removed.

For example, in the example shown in FIG. 16, it is assumed that the score of the second bounding box 212 is lower than the score of the first bounding box 211. In this case, the overlap removal unit 8 removes the second bounding box 212.

### [Second Method]

In the second method, the overlap removal unit 8 corrects the score of the bounding box by multiplying the score of the bounding box which is obtained by the detection unit with lower accuracy of detection operation among the first bounding box and the second bounding box by a predetermined coefficient. For example, in the example shown in FIG. 16, it is assumed that the first bounding box 211 is the bounding box obtained by the first detection unit 4 and the second bounding box 212 is the bounding box obtained by the second detection unit 5. Of the first detection unit 4 and the second detection unit 5, the second detection unit 5 is the one whose detection operation is less accurate. Therefore, the overlap removal unit 8 corrects the score of the second bounding box 212 obtained by the second detection unit 5 by multiplying the score of the second bounding box by the predetermined coefficient. Here, the predetermined coefficient has a value between 0 and 1, for example, a value between 0.5 and 0.7 is preferable.

Then, the overlap removal unit 8 compares the corrected score of the second bounding box 212 with the score of the other bounding box (i.e., the first bounding box 211), and removes the bounding box corresponding to the lower score. As a result, either the first bounding box or the second bounding box is removed.

In the second method, the bounding box obtained by the less accurate second detection unit 5 are more likely to be removed among the first bounding box and the second bounding box.

### [Third Method]

In the third method, the overlap removal unit 8 removes the first bounding box when the center of the first bounding box protrudes from the first partial image and removes the second bounding box when the center of the second bounding box protrudes from the second partial image.

For example, in the example shown in FIG. 16, the center of the first bounding box 211 protrudes from the first partial image 201. Therefore, the overlap removal unit 8 removes the first bounding box 211. The center of the second bounding box 212 does not protrude from the second partial image 202. Therefore, the overlap removal unit 8 leaves the second bounding box 212.

However, in the third method, it is possible that both the first bounding box and the second bounding box are not removed. Specifically, when the center of the first bounding box does not protrude from the first partial image and the center of the second bounding box does not protrude from the second partial image, both bounding boxes remain unremoved.

In the third method, both the first bounding box and the second bounding box may be removed. Specifically, when the center of the first bounding box protrudes from the first partial image and the center of the second bounding box also protrudes from the second partial image, both bounding boxes are removed.

The third method allows for cases where both the first bounding box and the second bounding box remain or where both the first bounding box and the second bounding box are removed, as described above.

The method of removing either the first bounding box or the second bounding box may be any of the first method, the second method and the third method described above, or any other method.

In the first method, the second method, and the third method described above, when removing a bounding box, the overlap removal unit 8 also removes the score and label corresponding to the bounding box.

The overlap removal unit 8 is realized, for example, by a CPU of a computer operating according to an object detection program. In this case, the CPU may read the object detection program from a program storage medium such as a program storage device of the computer, and operate as the division unit 2, the partial image input unit 3, the first detection unit 4, the second detection unit 5, the first NMS unit 6, the second NMS unit 7 and the overlap removal unit 8 according to the object detection program.

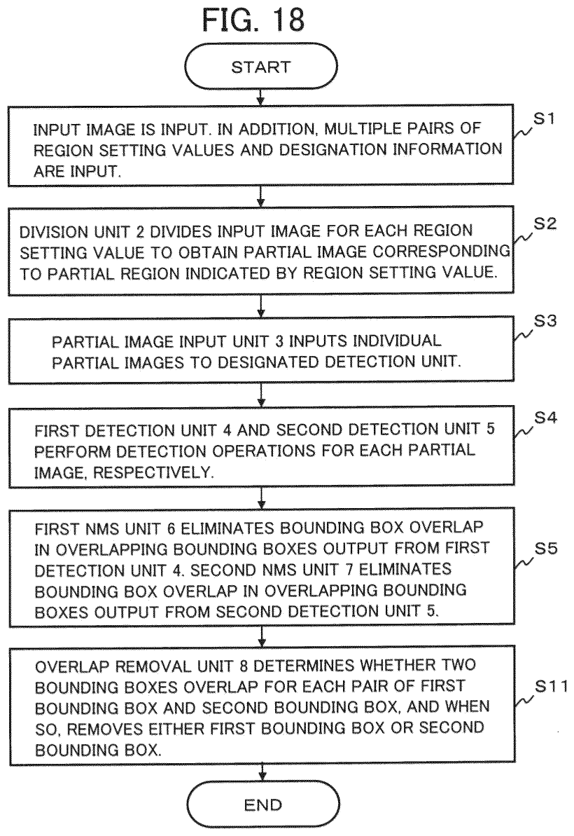

Next, the processing flow is explained. FIG. 18 is a flowchart showing an example of the processing flow of the object detection device of the second example embodiment. The explanation of matters that have already been explained are omitted as appropriate. Steps S1-S5 shown in FIG. 18 are the same as steps S1-S5 in the first example embodiment (see FIG. 14).

Next to step S5, the overlap removal unit 8 determines whether two bounding boxes overlap for each pair of the first bounding box and the second bounding box, and when so, removes either the first bounding box or the second bounding box (step S11).

In the second example embodiment, as in the first example embodiment, the time required to obtain detection result can be shortened. Furthermore, the second example embodiment can make it difficult to obtain two bounding boxes for one detection target object.

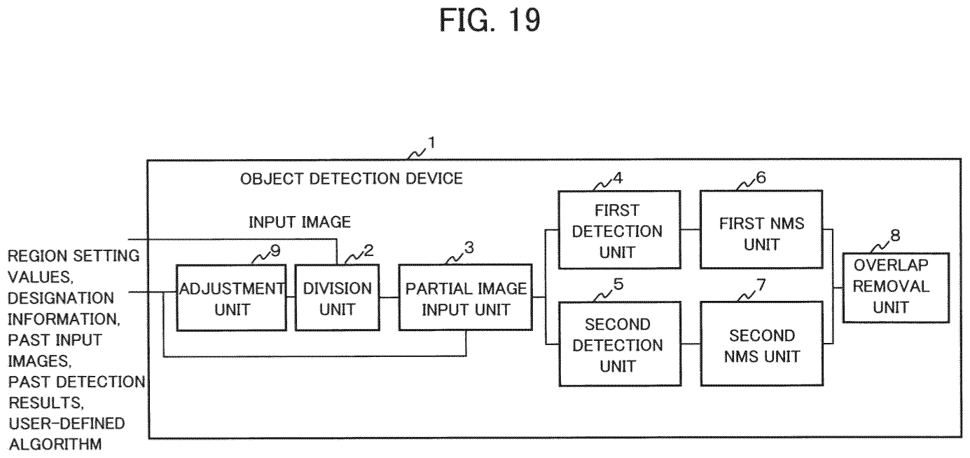

Next, a variant of each example embodiment is shown. FIG. 19 is a block diagram showing a variation of each example embodiment. The object detection device 1 of each example embodiment may include an adjustment unit 9 (see FIG. 19) that adjusts the input region setting values. In addition to the pair of region setting values and the designation information, past input images, past detection results obtained from those past input images, and information representing an algorithm defined by a user (hereinafter referred to as a user-defined algorithm) are input to the adjustment unit 9. The user-defined algorithm is input.

The user-defined algorithm represents an algorithm that dynamically adjusts the respective region setting values using the past input images and past detection results. The adjustment unit 9 dynamically adjusts (modifies) the respective input region setting values using the past input images and the past detection results according to the user-defined algorithm, and inputs the adjusted respective region setting values to the division unit 2. Accordingly, the division unit 2 divides the input image to obtain a partial image according to the respective region setting values after adjustment (after modification). Other operations are the same as those of each of the aforementioned example embodiments.

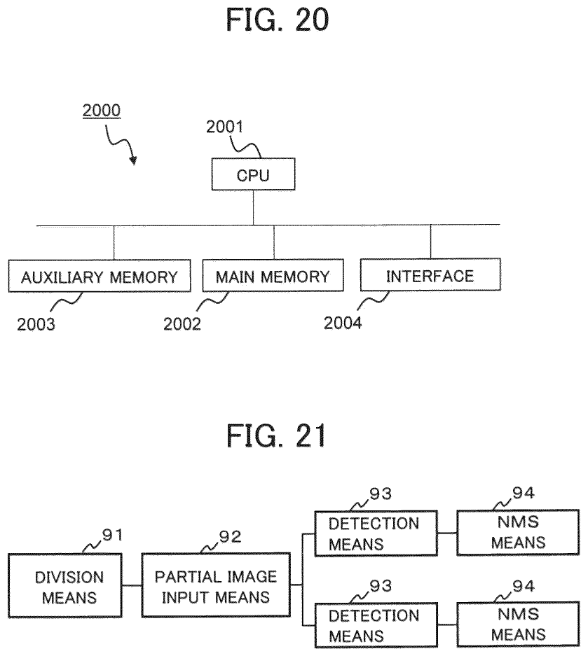

FIG. 20 is a schematic block diagram showing an example configuration of a computer related to the object detection device 1 of the present invention. The computer 2000, for example, includes a CPU 2001, a main memory 2002, an auxiliary memory 2003, and an interface 2004.

The object detection device 1 of each example embodiment of the present invention is realized, for example, by a computer 2000. The operation of the object detection device 1 is stored in the auxiliary memory 2003 in the form of a program (object detection program). The CPU 2001 reads the program from the auxiliary memory 2003, expands the program in the main memory 2002, and executes the process described in each of the above example embodiments and the variation according to the program.

The auxiliary memory 2003 is an example of a non-transitory tangible medium. Other examples of non-transitory tangible media include magnetic disks, magneto-optical disks, CD-ROM (Compact Disk Read Only Memory), DVD-ROM (Digital Versatile Disk Read Only Memory), semiconductor memory, etc., connected via interface 2004.

The following is an overview of the invention. FIG. 21 is a block diagram showing the overview of the object detection device of the present invention. The object detection device includes two or more detection means 93 that perform detection operation of deriving bounding boxes of a detection target object and scores indicating reliability of the bounding boxes, based on a given image. Accuracy of the detection operation of each detection means 93 is different. The object detection device includes division means 91, partial image input means 92, NMS (Non-Maximum Suppression) means 94, each of which is provided for each of the individual detection means 93.

The division means 91 (e.g., the division unit 2) divides an input image to obtain partial images corresponding to partial regions indicated by region setting values, when a pair of the region setting values that indicate the partial regions in the input image and designation information designating the detection means 93 to be input destination for partial images corresponding to the partial regions is given.

The partial image input means 92 (e.g., the partial image input unit 3) inputs the individual partial images to designated detection means 93.

Each NMS means 94 eliminates bounding box overlap in overlapping bounding boxes output from corresponding detection means 93.

The partial image input means 92 does not input a partial image for which no detection means 93 is designated as the input destination to any of the detection means 93.

Such a configuration can shorten the time required to obtain detection result.

The object detection device may include an overlap removal means (e.g., the overlap removal unit 8) that removes either a first bounding box or a second bounding box when the first bounding box and the second bounding box overlap, wherein the first bounding box is a bounding box obtained from a first partial image which is one of two adjacent partial images and overlapping with boundary of the two adjacent partial images, and the second bounding box is a bounding box obtained from a second partial image which is the other of the two adjacent partial images and overlapping with the boundary.

The overlap removal means may remove the bounding box with lower score among the first bounding box and the second bounding box.

The overlap removal means may correct the score of the bounding box by multiplying the score of the bounding box which is obtained by the detection means 93 with lower accuracy of detection operation among the first bounding box and the second bounding box by a predetermined coefficient, compare the corrected score with the score of the other bounding box, and remove the bounding box corresponding to lower score.

The overlap removal means may remove the first bounding box when center of the first bounding box protrudes from the first partial image and remove the second bounding box when center of the second bounding box protrudes from the second partial image.

The object detection process of YOLOX, etc., is slow. In particular, the object detection process of YOLOX-X is slow. For example, when a single image is input to an object detection device employing YOLOX, it takes time to obtain detection result.

According to the present invention, the time required to obtain detection result can be shortened.

The invention is suitably applied to an object detection device that derives bounding boxes, scores and labels from input images.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

What is claimed is:

1. An object detection device comprising:
a memory storing instructions; and
a processor configured to execute the instructions to implement:
two or more detection units that perform detection operation of deriving bounding boxes of a detection target object and scores indicating reliability of the bounding boxes, based on a given image,
wherein accuracy of the detection operation of each detection unit is different,
wherein the processor is further configured to execute the instructions to implement:
a division unit that divides an input image to obtain partial images corresponding to partial regions indicated by region setting values, when a pair of the region setting values that indicate the partial regions in the input image and designation information designating the detection unit to be input destination for partial images corresponding to the partial regions is given;
a partial image input unit that inputs the individual partial images to designated detection unit; and
NMS (Non-Maximum Suppression) units, each of which is provided for each of the individual detection units;
wherein each NMS unit eliminates bounding box overlap in overlapping bounding boxes output from corresponding detection unit, and
wherein the partial image input unit does not input a partial image for which no detection unit is designated as the input destination to any of the detection units.

2. The object detection device according to claim 1;
wherein the processor is further configured to execute the instructions to implement:
an overlap removal unit that removes either a first bounding box or a second bounding box when the first bounding box and the second bounding box overlap, wherein the first bounding box is a bounding box obtained from a first partial image which is one of two adjacent partial images and overlapping with boundary of the two adjacent partial images, and the second bounding box is a bounding box obtained from a second partial image which is the other of the two adjacent partial images and overlapping with the boundary.

3. The object detection device according to claim 2;
wherein the overlap removal unit removes the bounding box with lower score among the first bounding box and the second bounding box.

4. The object detection device according to claim 2;
wherein the overlap removal unit corrects the score of the bounding box by multiplying the score of the bounding box which is obtained by the detection unit with lower accuracy of detection operation among the first bounding box and the second bounding box by a predetermined coefficient, compares the corrected score with the score of the other bounding box, and removes the bounding box corresponding to lower score.

5. The object detection device according to claim 2;
wherein the overlap removal unit removes the first bounding box when center of the first bounding box protrudes from the first partial image and removes the second bounding box when center of the second bounding box protrudes from the second partial image.

6. A object detection method implemented in an object detection device comprising: two or more detection units that perform detection operation of deriving bounding boxes of a detection target object and scores indicating reliability of the bounding boxes, based on a given image, wherein accuracy of the detection operation of each detection unit is different,
wherein a division unit divides an input image to obtain partial images corresponding to partial regions indicated by region setting values, when a pair of the region setting values that indicate the partial regions in the input image and designation information designating the detection unit to be input destination for partial images corresponding to the partial regions is given;
a partial image input unit inputs the individual partial images to designated detection unit; and
NMS (Non-Maximum Suppression) units, each of which is provided for each of the individual detection units, eliminate bounding box overlap in overlapping bounding boxes output from corresponding detection unit, and
wherein the partial image input unit does not input a partial image for which no detection unit is designated as the input destination to any of the detection units.

7. The object detection method according to claim 6,
wherein an overlap removal unit removes either a first bounding box or a second bounding box when the first bounding box and the second bounding box overlap, wherein the first bounding box is a bounding box obtained from a first partial image which is one of two adjacent partial images and overlapping with boundary of the two adjacent partial images, and the second bounding box is a bounding box obtained from a second partial image which is the other of the two adjacent partial images and overlapping with the boundary.

8. A non-transitory computer-readable recording medium in which an object detection program is recorded, wherein the object detection program allows a computer to function as an object detection device,
wherein the object detection device comprises:
two or more detection units that perform detection operation of deriving bounding boxes of a detection target object and scores indicating reliability of the bounding boxes, based on a given image,
wherein accuracy of the detection operation of each detection unit is different,
wherein the object detection device further comprises:
a division unit that divides an input image to obtain partial images corresponding to partial regions indicated by region setting values, when a pair of the region setting values that indicate the partial regions in the input image and designation information designating the detection unit to be input destination for partial images corresponding to the partial regions is given;
a partial image input unit that inputs the individual partial images to designated detection unit; and
NMS (Non-Maximum Suppression) units, each of which is provided for each of the individual detection units;
wherein each NMS unit eliminates bounding box overlap in overlapping bounding boxes output from corresponding detection unit, and
wherein the partial image input unit does not input a partial image for which no detection unit is designated as the input destination to any of the detection units.

9. The non-transitory computer-readable recording medium according to claim 8,
wherein the object detection program allows the computer to function as the object detection device,
wherein the object detection device comprises:
an overlap removal unit that removes either a first bounding box or a second bounding box when the first bounding box and the second bounding box overlap, wherein the first bounding box is a bounding box obtained from a first partial image which is one of two adjacent partial images and overlapping with boundary of the two adjacent partial images, and the second bounding box is a bounding box obtained from a second partial image which is the other of the two adjacent partial images and overlapping with the boundary.
